(19) United States
(12) Patent Application Publication
(10) Pub. No.: US 2004/0096809 A1
(43) Pub. Date: May 20, 2004

(54) Reading air

(76) Inventor: Christina Eriksson, Taby (SE)

Correspondence Address: Rolf Fasth, Fasth Law Offices, 629 E Boca Raton Road, Phoenix, AZ, 85022, US

(21) Appl. No.: 10/362,781

(22) PCT Filed: Sep. 17, 2001
(86) PCT No.: PCT/SE01/01977

(30) Foreign Application Priority Data
Sep. 19, 2000 (SE) 0003340-7

(51) Int. Cl. G09B 21/00

(52) U.S. Cl. 434/113

(57) ABSTRACT

The present invention relates to a reading aid that generally is in the shape of a ruler (1; 1′; 1″; 1′″). The reading aid according to the present invention may for instance be used in school but also in office environments. The reading aid is certainly not restricted to be used in connection with letters, figures or signs of that type, but it is also feasible to use the aid to “read” or aim stitches, e.g. in connection with embroidery. It is significant for the reading aid according to the present invention that the ruler (1; 1′; 1″; 1′″) is equipped with a tongue (3; 3′; 3″; 3′″) that is integral with the ruler (1; 1′; 1″; 1′″), and that a grooving line (7) between the ruler (1; 1′; 1″; 1′″) and the tongue (3; 3′; 3″; 3′″) extends transverse to de longitudinal direction of the ruler (1; 1′; 1″;1′″).

### TECHNICAL FIELD OF THE INVENTION

The present invention relates to a reading aid that generally is in the shape of a ruler. The reading aid according to the present invention may for instance be used in school but also in office environments. The reading aid is certainly not restricted to be used in connection with letters, figures or signs of that type, but it is also feasible to use the aid to “read” or aim stitches, e.g. in connection with embroidery.

### PRIOR ART

From GB 2 114 514 it is previously known a reading aid that is in the shape of a device constituting a double walled clip where for instance one page of a book is received between the walls of the clip. That device also has a translucent area through which the text to be read is visible. The providing of a translucent area brings about that the manufacturing cost of the reading aid according to GB 2 114 514 is comparatively high. The walls of the reading aid are mutually connected by means of a fold having an inherent resilience that urges the walls against each other by a certain force. It may be difficult, in connection with the manufacturing of the reading aid according to GB 2 114 514, to achieve a proper force that urges the walls towards each other. A too large force makes it difficult to displace the reading aid along the page while a too small force brings about that the reading aid may easily fall down from the page that the reading aid is mounted upon. It may also occur that the reading aid is clamped in only one point/small area, which may result in an obliquity in connection with displacement.

### OBJECTS AND FEATURES OF THE INVENTION

A primary object of the present invention is to present a reading aid of the type defined above that structurally is extremely simple but still functions in a user-friendly way.

A further object of the present invention is that the manufacturing cost of the reading aid should be comparatively low.

Still an object of the present invention is that the reading aid should be manufactured from a material that may be recycled.

At least the primary object of the present invention is realised by means of a reading aid that is characterised by the ruler having a tongue at one end, said tongue being integral with the ruler and punched from the ruler.

### BRIEF DESCRIPTION OF THE DRAWINGS

Below embodiments of the reading aid according to the present invention will be described, where:

FIG. 1 shows a top view of first embodiment of the reading aid according to the present invention;

FIG. 2 shows a top view of a second embodiment of the reading aid according to the present invention;

FIG. 3 shows a top view of a third embodiment of the reading aid according to the present invention;

FIG. 4 shows the reading aid according to FIG. 3 mounted on a page of a book or the like;

FIG. 5 shows a top view of a fourth embodiment of the reading aid according to the present invention; and

FIG. 6 shows the reading aid according to FIG. 5 mounted on the page of a book or the like.

### DETAILED DESCRIPTION OF THE PREFERRED EMBODIMENTS OF THE READING AID ACCORDING TO THE PRESENT INVENTION

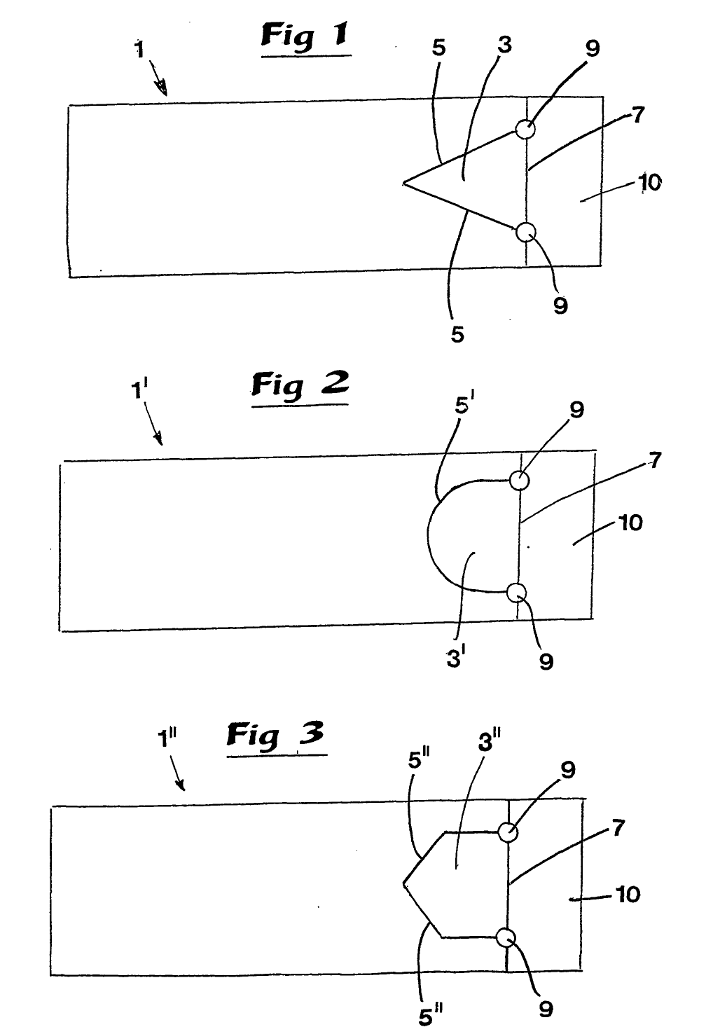

In FIG. 1 a reading aid according to the present invention is shown, said reading aid generally being in the shape of a rectangular ruler 1 that at one end is provided with a tongue 3, said tongue 3 being integral with the ruler 1. The tongue 3 is generally triangular, said tongue 3 being defined on one hand by two cuts 5 in the ruler 1, said cuts 5 meeting in a common point, and on the other hand by a grooving line 7 of the ruler 1, said grooving line 7 extending between the ends of the cuts 5 that face away from the common point. The common point of the cuts 5 forms a tip of the tongue 3.

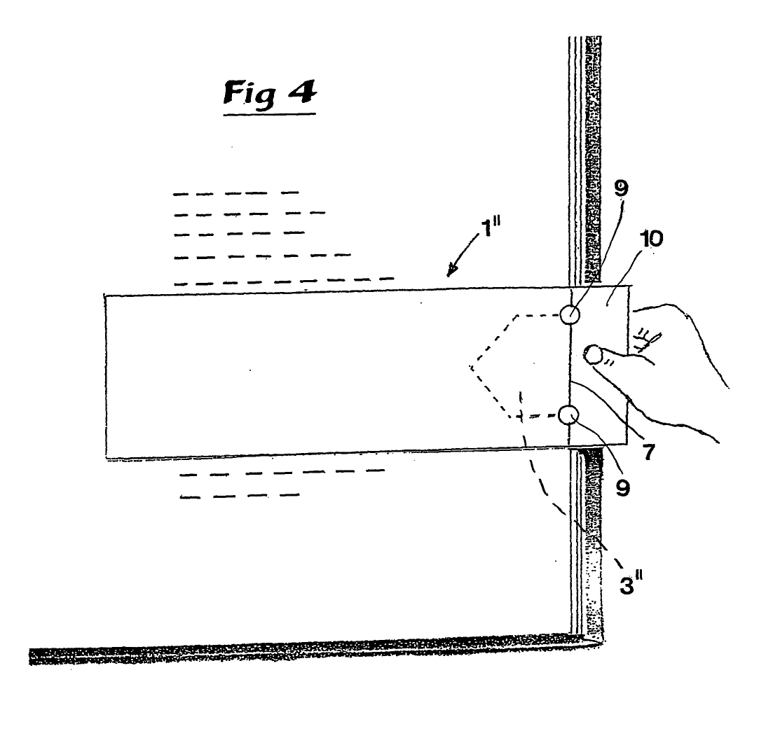

As is evident from FIG. 1 a hole 9 is provided in each of the areas of the ruler 1 where the cuts 5 connect to the moving line 7, said holes 9 being circular in the shown embodiment. The ruler 1 is thus equipped with two holes 9. The function of these holes 9 is to allow the ruler 1 to be more easily displaced along the page that the ruler 1 is mounted upon. This will be described more in detail below with reference to FIG. 4.

In the area of its right end in FIG. 1 the ruler 1 is equipped with a gripping portion 10 that the user grips when the ruler 1 is to be mounted upon a page or displaced along said page.

The embodiment disclosed in FIG. 2 of a reading aid according to the present invention is likewise in the shape of a ruler 1′. The only principal difference between the embodiment according to FIG. 2 and the embodiment according to FIG. 1 is the shape of the tongue 3′, where the tongue 3′ of the embodiment according to FIG. 2 is partly defined by a cut 5′ that is composed of a semi circle and substantially straight lines that join the grooving line 7.

The embodiment disclosed in FIG. 3 of a reading aid according to the present invention is likewise in the shape of a ruler 1″. The only principal difference between the embodiment according to FIG. 3 and the embodiment according to FIG. 1 is the shape of the tongue 3″, where the tongue 3″ of the embodiment according to FIG. 3 is partly defined by a cut 5″ that is composed of a number of straight lines, the lines located to the left in FIG. 3 meeting in a tip.

In FIG. 4 it is shown how the reading aid according to FIG. 3 is mounted on a page of a book. With one of his hands the user grips the gripping portion 10 and mounts the ruler 1″ on the page of the book in such a way that the tongue 5″ is located at the backside of the page of the book, i.e. on the side that faces away from the text that is about to be read. Since the ruler 1″ preferably is manufactured from a suitable material having a certain inherent resilience, e.g. a polystyrene plastic, the ruler 1″ will fasten on the page of the book. However, the clamping force from the tongue 5″ will not prevent the ruler 1″ to be displaced along the book page. The holes 9 in the ruler 1″, said holes 9 being provided in connection with the grooving line, facilitates the displacement of the ruler 1″ along the book page, i.e. said holes 9 prevent the ruler 1″ from catching in the page of the book when displacing the ruler 1″ along the book page.

In FIG. 4 the upper edge of the ruler 1″ constitutes the edge along which reading takes place since a number of the text lines located below are covered by the ruler 1″. As is realised by studying FIG. 4 the ruler 1″ is thus mounted at the upper part of the page and then the ruler 1″ is displaced downwards on the page of the book meanwhile the reading continues.

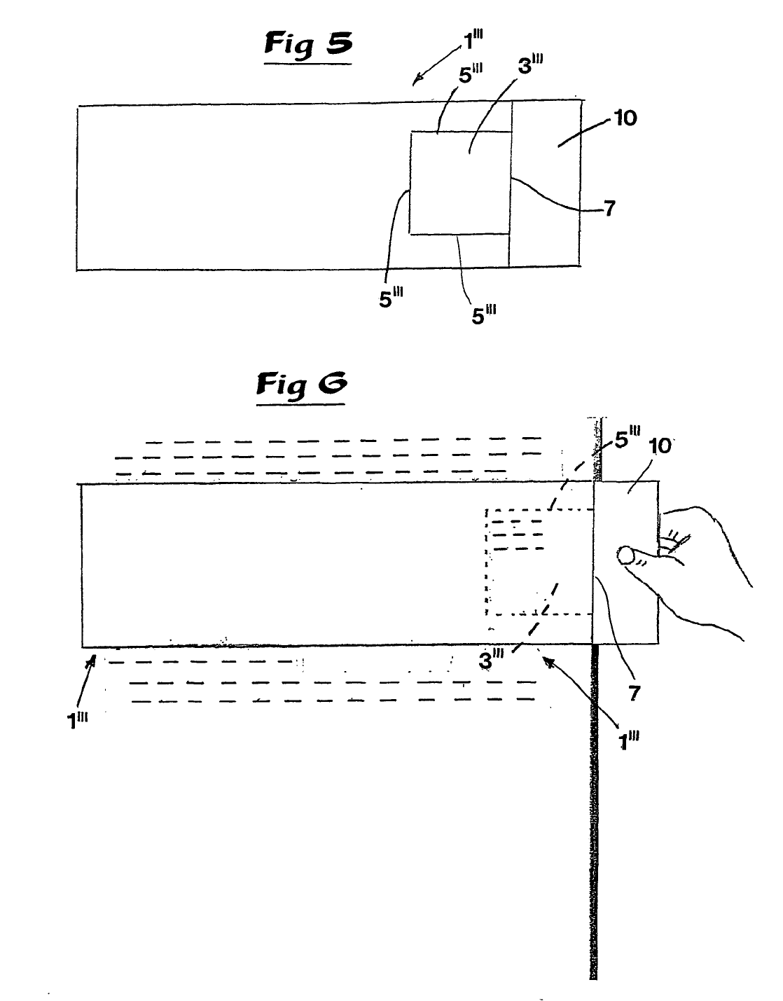

The embodiment shown in FIG. 5 of a reading aid according to the present invention is likewise in the shape of a ruler 1′″. The principal difference between the embodiment according to FIG. 5 and the embodiment according to FIG. 1 is on one hand the shape of the tongue 3′″ and on the other hand the absence of holes at the joining of the tongue 3′″ to the grooving line 7. As is evident from FIG. 5 the tongue 3′″ has square shape, i.e. the cuts 5′″ run in perpendicular direction to each other.

In FIG. 6 the ruler 1′″ is mounted on a page of a book and it functions on principle in the same way as the ruler 1″ shown in FIG. 4.

### Feasible Modifications of the Invention

The embodiments described above certainly show a number of tongues 3; 3′; 3″; 3′″ of different shape. However, this exemplifying is in no way exhaustive. The shape of the tongues may vary further within the scope of the present invention although the tongues must have a proper function, i.e. they must be able to clamp the ruler on a page of a book in an acceptable way.

As regards the material that the reading aid is made from, polystyrene plastic has been mentioned above. However, within the scope of the invention it is feasible to use other plastic materials having the desired properties. In exemplifying and non-restricting purpose PET and PVC may be mentioned. Certain wood based materials, in the shape of a thin veener, are also feasible as material for the reading aid according to the present invention.

The length of the ruler a of the reading aid according to the present invention may also be varied in accordance to the width of the pages where the reading aid is to be used. In this connection it should be mentioned that the ruler could be equipped with a measuring scale along one longitudinal edge.

Within the scope of the present invention it is also feasible that the ruler, in the area of one of its longitudinal edges, has a magnification function, the ruler in such a case being manufactured from a translucent material. Furthermore, in the area of said longitudinal edge the material must be designed in such away that it refracts the light to achieve a magnification of the underlying text. In this case the reading is not effected along the longitudinal edge, but the ruler could be equipped with an auxiliary line, along which reading takes place.

As regards the shape of the ruler itself it must not be rectangular. However it is important that the upper edge, i.e. the edge that reading normally is effected along, is straight. Besides that, the shape of the ruler may vary within reasonable and practical limits.

1. Reading aid that generally is in the shape of a ruler (1; 1′; 1″; 1′″), said ruler (1; 1′; 1″; 1′″) being equipped with a tongue (3; 3′; 3″; 3′″) that is integral with the ruler (1; 1′; 1″; 1′″), and that a grooving line (7) between the ruler (1; 1′; 1″; 1′″) and the tongue (3; 3′; 3″; 3′″) extends transverse to de longitudinal direction of the ruler (1; 1′; 1″; 1′″), characterized in that the tongue (3; 3′; 3″; 3′″) is punched from the ruler (1; 1′; 1″; 1′″) and provided solely in the area of one end of the ruler (1; 1′; 1″; 1′″), and that the tongue (3; 3′; 3″; 3′″), in inactive condition of the reading aid, is located essentially in the same plane as the ruler (1; 1′; 1″; 1 ′″).

2. Reading aid according to claim 1,
characterized in that the tongue (3) has triangular shape.

3. Reading aid according to claim 1,
characterized in that the tongue (3′) has essentially semi circular shape.

4. Reading aid according to claim 1,
characterized in that the tongue (3′″) has rectangular shape.

5. Reading aid according to any of the previous claims,
characterized in that the ruler (1; 1′; 1″; 1′″) is provided with holes (9) in the area of the ends of the grooving line (7).

6. Reading aid according to any of the previous claims,
characterized in that the ruler (1; 1′; 1″; 1′″) is manufactured from a plastic material.

7. Reading aid according to claim 6,
characterized in that the plastic material is polystyrene.
